(19) United States
(12) Patent Application Publication
(10) Pub. No.: US 2006/0035039 A1
(43) Pub. Date: Feb. 16, 2006

(54) Silver-releasing articles and methods of manufacture

(75) Inventors: Caroline M. Ylitalo, Stillwater, MN (US); Jeffrey H. Tokie, Scandia, MN (US); Matthew T. Scholz, Woodbury, MN (US); Prabhakara S. Rao, Maplewood, MN (US); Stephen E. Krampe, Maplewood, MN (US); Mark J. Hendrickson, Minneapolis, MN (US); Peter T. Elliott, Woodbury, MN (US); Scott A. Burton, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/917,002

(22) Filed: Aug. 12, 2004

(51) Int. Cl. B41M 5/00; B05D 1/02; B05D 5/00

(52) U.S. Cl. 428/32.22; 427/421.1

(57) ABSTRACT

The present invention is a method of coating an article having a surface. The method includes combining a sparingly soluble silver-containing compound, a solubilizer, and an aqueous solvent, thereby forming a fluid solution. The fluid solution is non-contact deposited on the surface and allowed to substantially dry.

### BACKGROUND OF THE INVENTION

The present invention relates to a method of applying silver-containing compounds to articles. In particular, the present invention relates to a method of solubilizing silver-containing compounds in fluid solutions and applying fluid solutions to articles by non-contact deposition.

Wound care articles, such as bandages and wound dressings, are available in a variety of designs to protect wounds from environmental conditions during the healing process. In general, wounds generally heal more effectively in moist environments. However, such environments also increase the risk of bacterial infection. To reduce this risk, many wound care articles are designed to release biological actives, such as antimicrobials, to prevent or treat bacterial infections.

Silver is well known for imparting antimicrobial activity to a surface with minimal risk of developing bacterial resistance. Silver ions are broad spectrum antimicrobials that kill microorganisms without significant negative effects on human cells. In contrast to antibiotics, silver ions are rarely associated with microbial resistance. As such, the systematic use of silver-containing compounds generally does not generate concerns in the medical field over antibiotic-resistant bacteria.

Certain silver-containing compounds, such as silver oxides and select silver salts, referred to as sparingly soluble silver-containing (SSSC) compounds, exhibit low solubility in aqueous solvents. As such, SSSC compounds are difficult to directly disperse or dissolve in solutions. This renders the SSSC compounds excellent sources for slow and sustained release of silver ions. As such, exposure of such silver ions to moisture of a wound bed allows the silver ions to slowly release into the moisture to reduce the risk of infections. However, because of the low solubility, attempts to coat substrates with SSSC compounds have reached limited success, leaving limited quantities of the compounds on the substrates. As such, there is a need for a method of preparing articles with effective amounts of SSSC compounds.

### BRIEF SUMMARY OF THE INVENTION

The present invention relates to a method of coating an article having a surface, and includes combining a sparingly soluble silver-containing compound, an ammonium-containing compound, and an aqueous solvent, thereby forming a fluid solution. The fluid solution is non-contact deposited on the surface and allowed to substantially dry.

The present invention further relates to a method of coating an article having a surface, and includes combining silver oxide, ammonium carbonate, and an aqueous solvent, thereby forming a fluid solution. The fluid solution is non-contact deposited on the surface and allowed to substantially dry.

The present invention further relates to a method of coating an article having a surface, and includes combining silver acetate, a dispersant, and an aqueous solvent, thereby forming a fluid solution. The fluid solution is non-contact deposited on the surface and allowed to substantially dry.

The present invention further relates to a method of coating an article having a surface, and includes combining a sparingly soluble silver-containing compound, an ammonium-containing compound, and an aqueous solvent, thereby forming a first fluid solution. The method also includes providing a second fluid solution comprising a biological active. The first fluid solution and the second fluid solution are non-contact deposited on the surface and are allowed to substantially dry.

The present invention further relates to an article having a surface and a sparingly soluble silver-containing compound deposited on the surface by non-contact deposition of a fluid solution. The fluid solution is formed by combining the sparingly soluble silver-containing compound, an ammonium-containing compound, and an aqueous solvent.

### BRIEF DESCRIPTION OF THE DRAWINGS

FIG. 1 is a sectional view of a wound dressing article of one embodiment of the present invention.

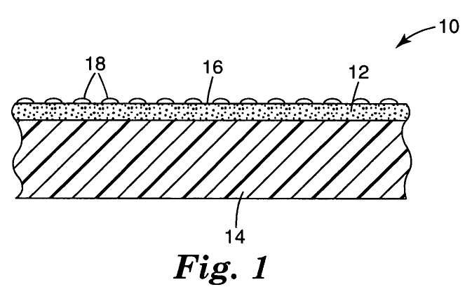

While FIG. 1 sets forth only one embodiment of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figure may not be drawn to scale.

### DETAILED DESCRIPTION

The present invention relates to a method of applying SSSC compounds to articles by non-contact deposition. The method involves forming a fluid solution by mixing a SSSC compound and a solubilizer in an aqueous solvent, where the solubilizer complexes with the SSSC compound to dissolve and/or disperse the SSSC compound in the aqueous solvent. The fluid solution is then applied to an article (e.g., a wound dressing) by non-contact deposition, and is allowed to substantially dry. As used herein, the terms “sparingly soluble silver-containing compound” and “SSSC compound” are defined as a silver-containing compound that, without the assistance of a solubilizer, is only soluble in water up to about 10.0 grams per liter of water. The present invention, however, is particularly useful for SSSC compounds that, without the assistance of a solubilizer, are only soluble in water up to about 0.1 grams per liter of water.

The antimicrobial activity of silver is believed to be due to free silver ions or radicals, where the silver ions kill microbes by blocking the cell respiration pathway (by attaching to the cell DNA and preventing replication) and by disruption of the cell membrane. As such, the SSSC compounds suitable for the present invention provide antimicrobial activity by a sustained release of silver ions from the coated article when in contact with moist environments, such as a wound bed.

Examples of suitable SSSC compounds include silver oxide, silver sulfate, silver acetate, silver chloride, silver phosphate, silver stearate, silver thiocyanate, silver proteinate, silver carbonate, silver sulfadiazine, silver alginate, and combinations thereof. Examples of particularly suitable SSSC compounds include silver oxides, silver carbonates, and silver acetates. Examples of suitable concentrations of the SSSC compound in the fluid solution range from about 0.1% to about 15.0% by weight, based on the total weight of the fluid solution. Examples of particularly suitable concentrations of the SSC compound in the fluid solution range from about 1.0% to about 5.0% by weight, based on the total weight of the fluid solution.

Non-contact deposition techniques suitable for the present invention are generally independent of the article surface being coated. As such, a non-contact deposition mechanism may be moved in a transverse direction to the surface being coated, while imparting substantially no transverse force to the surface. In contrast to contact coating techniques, non-contact deposition allows the same processing equipment to be used for coating a variety of different surfaces without requiring changes in formulations or process parameters. Non-contact deposition techniques, however, generally require that the deposited substance be in a fluid medium (e.g., water) that exhibits a sufficiently low viscosity. This presents an issue for SSSC compounds, which exhibit low solubilities in aqueous solvents.

To accommodate for the low solubility of the SSSC compound in aqueous solvents, the SSSC compound may be mixed with a solubilizer in the aqueous solvent, thereby forming the fluid solution, which is stable enough to allow non-contact deposition. Preferably, the fluid solution is stable over a period of time, such as at least one month, without significant precipitation of the SSSC compound from the fluid solution. This allows the fluid solution to be prepared and stored prior to use. However, a fluid solution is considered stable for the purposes of the present invention if the SSSC compound remains substantially dissolved and/or dispersed in the aqueous solvent long enough to be applied by non-contact deposition.

In one embodiment, the solubilizer may be an ammonium-containing compound. The ammonium-containing compound complexes with the SSSC compound to substantially dissolve the SSSC compound in the aqueous solvent. This allows the fluid solution of the present invention to include SSSC compounds while also exhibiting adequate viscosities for non-contact deposition. Depending on the SSSC compound used, the SSSC compound may readily dissolve in the aqueous solvent at room temperature when mixed with the ammonium-containing compound. If not, mechanical action such as stirring over time and/or heat may be required to aid the dissolution.

Examples of suitable ammonium-containing compounds include ammonium salts such as ammonium pentaborate, ammonium acetate, ammonium carbonate, ammonium chloride, ammonium peroxyborate, ammonium tertraborate, triammonium citrate, ammonium carbamate, ammonium bicarbonate, ammonium malate, ammonium nitrate, ammonium nitrite, ammonium succinate, ammonium sulfate, ammonium tartarate, and combinations thereof. The concentration of the ammonium-containing compound in the fluid solution 18 is desirably the minimum required to dissolve the SSSC compound used. Examples of suitable concentrations of the ammonium-containing compound in the fluid solution range from about 1.0% to about 25% by weight, based on the total weight of the fluid solution.

An example of particularly suitable materials for the fluid solution of the present invention include silver oxide, ammonium carbonate, and an aqueous solvent, such as water. While not wishing to be bound by theory, it is believed that the silver oxide and the ammonium carbonate complex to dissolve the silver oxide in the aqueous solvent. The complexing creates a silver ammonium carbonate compound. The fluid solution is then applied to an article by non-contact deposition. During the non-contact deposition, a portion of the ammonium carbonate readily evaporates because of the large surface area of the deposited fluid solution. This is observable by a strong ammonia odor.

As the fluid solution dries, silver oxide is reformed on the article surface. This is believed to be due to the decomplexation of the silver ammonium carbonate compound into silver oxide, ammonia, carbon dioxide, and water. The ammonia, carbon dioxide, and water then evaporate. The decomplexation of the silver oxide is observable by a color change. Prior to drying, the fluid solution is colorless. However, after drying, the residual portion of the fluid solution turns dark brown, which is a typical characteristic of silver oxide. As such, after non-contact deposition, the ammonium carbonate and the water are removed, leaving silver oxide disposed on the article surface.

With regards to silver oxide, a variety of valence states of the silver oxide may be used (e.g., where the oxidation state is silver (II) oxide or silver (III) oxide). The valence state of the silver oxide on the article surface may be determined by depositing a silver oxide of a given valence state (e.g., Ag₂O, AgO, Ag₂O₃, Ag₂O₄). Alternatively, the valence state of the silver oxide may be increased by including an oxidizing agent to the fluid solution of the present invention, or applying an oxidizing agent to the article surface after applying the fluid solution to the article surface by non-contact deposition. Examples of suitable oxidizing agents include hydrogen peroxide, alkali metal persulfates, permanganates, hypochlorites, perchlorates, nitric acid, and combinations thereof An example of a suitable alkali metal persulfate includes sodium persulfate as discussed in Antelman, U.S. Pat. No. 6,436,420, which is incorporated by reference in its entirety.

In another embodiment, which uses silver acetate as the SSSC compound, the solubilizer may be a dispersant used to disperse the silver acetate in the aqueous solvent. Similar to the ammonium-containing compounds discussed above, the dispersant is believed to complex with silver acetate. As such, the acetate component of the silver acetate compound exists as a counter ion in association with the silver-dispersant adduct. This creates a stable dispersion of the silver acetate in the aqueous solvent that exhibits a sufficiently low viscosity to allow application by non-contact deposition.

Suitable dispersants for use with the silver acetate are preferably nonionic, and may include surfactants commercially available under the trade designation “PLURONICS” from BASF, Spartanburg, S.C.; surfactants commercially available under the trade designation “BRIJ” from Imperial Chemical Industries PLC, London, UK; polyethylene oxide and polypropylene oxide copolymers; polyoxyethylene stearyl ethers; polyoxyethylene lauryl ethers; dioctyl sodium sulfosuccinates; alkylpolyglucosides; polyglyceryl esters; dioctylsulfosuccinates; and combinations thereof. Examples of suitable concentrations of the dispersant in the fluid solution range from about 1.0% to about 20.0% by weight, based on the total weight of the fluid solution.

Additionally, an ammonium-containing compound may also be used with the dispersant to complex with the silver acetate in the same manner as discussed above for silver oxide. This further increases the solubility of the silver acetate in the aqueous solvent, allowing a greater concentration of the silver acetate to be dissolved and/or dispersed in the aqueous solvent.

The aqueous solvent of the fluid solution is preferably water. However, other solvents may also be used with water, such as propylene glycol, ethylene glycol, glycerol, methanol, ethanol, isopropanol, and combinations thereof. Such solvents may be used for a variety of purposes, such as modifying the volatility of the fluid solution and modifying the solubility of the SSSC compound.

The fluid solution may also include a variety of additional materials to enhance the properties of the fluid solution and/or the SSSC compound. Examples of suitable additional materials include plasticizers, binders, excipients, dyes, pigments, surfactants, enhancers, and combinations thereof. While referred to as a “solution”, the fluid solution may be a dispersion, an emulsion, a solution, and combinations thereof.

Examples of suitable non-contact deposition techniques for use with the present invention include inkjet printing, spray atomization deposition, electrostatic deposition, microdispensing, and mesoscale deposition. Particularly suitable non-contact deposition techniques include inkjet printing and spray atomization deposition.

Inkjet printing operates by ejecting the fluid solution onto an article surface in controlled patterns of fluid droplets. Examples of suitable inkjet printing methods include thermal inkjet, continuous inkjet, piezo inkjet, bubble inkjet, drop-on-demand inkjet, and acoustic inkjet. Printheads for such printing methods are commercially available from Hewlett-Packard Corporation, Palo Alto, Calif. and Lexmark International, Lexington, Ky.(thermal inkjet); Domino Printing Sciences, Cambridge, UK (continuous inkjet); and Trident International, Brookfield, Conn., Epson, Torrance, Calif., Hitachi Data Systems Corporation, Santa Clara, Calif., Xaar PLC, Cambridge, UK, Spectra, Lebanon, N.H., and Idanit Technologies, Ltd., Rishon Le Zion, Israel (piezo inkjet).

Examples of a suitable inkjet printhead models include the NOVA series such as the NOVA-Q printhead commercially available from Spectra Inc., and the XJ128 series such as the XJ128-200 printhead commercially available from Xaar PLC. When using the XJ128-200 printhead, the fluid solution may be coated on the article surface by piezoelectrically driving the printhead at 1.25 kilohertz (kHz) and 35 volts (V), with a printing resolution of 300×300 dots-per-inch (dpi). This generates drops with nominal volumes of about 70 picoliters (pL).

Based on the printing resolution, the percent of the article surface covered (i.e., pixel coverage), and the concentration of the SSSC compound in the fluid solution, the concentration of the SSSC compound (Concentration_{SSSC}) applied on the article may be determined as follows:

$${Concentration}_{SSSC} = \begin{matrix}( \frac{\# ofDrops}{{( Inch )}^{2}} ) ( \frac{\% Coverage}{100} ) ( \frac{Volume}{Drop} ) \\ ( {Density}_{F . S .} ) ( \frac{Wt {\%}_{SSSC}}{100} )\end{matrix}$$

The (#ofDrops/Inch²) is the number of print pixels in a square inch of the substrate and is based on the selected printing resolution, and the (%Coverage/100) is the fraction of the article surface that is printed on. For example, with a printing resolution of 300×300 dpi and a 100% surface coverage of the article surface, a total of 90,000 drops of the fluid solution are deposited per square inch of the article surface. By this definition, the percent coverage may be greater than 100%, where a fraction of the pixels are double printed as the printhead executes multiple passes over the article. For example, with a printing resolution of 300×300 dpi and a 200% surface coverage of the article surface, a total of 180,000 drops of the fluid solution are deposited per square inch of the article surface, where 90,000 drops are deposited in the first pass of the printhead, and another 90,000 drops are deposited over the first set of drops in a second pass.

The (Volume/Drop) is the nominal volume of the drops generated by the selected printhead (e.g., 70 pL is the drop volume typically generated by the XJ128-200 printhead). The (Density_{F.S.}) is the average density of the fluid solution and the (Wt %_{SSSC}/100) is the weight percent concentration of the SSSC compound in the fluid solution prior to inkjet printing.

The percentage surface coverage that the fluid solution is inkjet printed on the article surface may vary as individual needs may require. The percentage required generally depends upon the composition of the fluid solution, including the SSSC compound, the activity level of the selected SSSC compound, and the level of antimicrobial activity desired. Examples of suitable percentage surface coverages of the fluid solution inkjet printed onto the article surface range from about 1% to about 500%.

Based on a printing resolution of 300×300 dpi, a fluid solution containing 1.0% silver oxide as the SSSC compound, which is inkjet printed at a 100% surface coverage onto an article surface provides about 0.06 milligrams/inch² (mg/inch²) (about 93 milligrams/meter²) of the silver oxide. This concentration of silver oxide is significantly lower than concentrations of silver reported in conventional antimicrobial articles. However, despite the low concentration, the article prepared pursuant to the present invention exhibits good antimicrobial activity to reduce the risk of infections.

Inkjet printing also allows for the creation of indicia and graphics on the article surface. As such, the pattern that the fluid solution is inkjet printed onto the article surface may also convey textual and graphical messages. In one embodiment, the messages may be visually observable through the use of pigments or dyes contained in the fluid solution, which remain concentrated on the article surface when the fluid solution substantially dries. Preferably, however, the SSSC compound itself provides coloration for the messages on the article surface. For example, silver oxide is clear when in the fluid solution, but turn a dark brown color when dried. This precludes the need for additional colorants to render the inkjet printed patterns visually observable. Examples of suitable messages include company logos, instructions for use of the article, brand names, and designs for aesthetic appearance.

Spray atomization deposition operates by emitting the fluid solution through an air impingement nozzle or air stripping nozzle to atomize the fluid solution to some degree. The atomized fluid solution is then directed onto the article surface. An example of suitable spray atomization deposition systems include commercially available spray heads and bodies, such as those from Spraying Systems Co., Wheaton, Ill. The spray heads may also include fan spray adaptations to fan out the primary atomization sources for creating elliptical patterns. Suitable operating conditions include spraying the fluid solution on the article surface with a volumetric flow rate of about 5 milliliters/minute (mL/min), a web speed of about 15 feet/minute (about 4.6 meters/minute), an atomizer nozzle setting of about 23 pounds/inch² (psi) (about 159 kilopascals (kpa)), and a fan nozzle setting of about 20 psi (about 138 kpa).

The spray head generates droplets with diameters ranging from about 2 micrometers to about 20 micrometers. After the fluid solution dries, the remaining dried droplets on the article exhibit diameters ranging up to about 30 micrometers due to agglomerated droplets. The amount of the SSSC compound sprayed on the article may be determined in a variety of manners, such as by determining the spray rate of the fluid solution and the line speed of the article. This is useful where the fluid solution diffuses into the article. Alternatively, for fluid solutions that exhibit low solubilities with the article surface, the concentration of the SSSC compound concentrated on or near the article surface may be determined pursuant to the method described in the concurrently filed patent application, attorney docket no. 59804US002, entitled “Biologically-Active Adhesive Articles And Methods Of Manufacture” (referred to herein as “the 59804US002 application”).

The fluid solution may also be deposited on the article through separate non-contact deposition systems, such as a plurality of inkjet printing systems. For example, a first inkjet printing system may print a first fluid solution containing a first SSSC compound, and a second inkjet printing system may print a second fluid solution containing a second SSSC compound or another biological active. Either fluid solution may be inkjet printed first, or they may be inkjet printed simultaneously. Alternatively, an inkjet system may be used to deposit the SSSC compound and a spraying system may be used to deposit the second biological active (or vice versa).

The fluid solution may also be deposited by non-contact deposition in a concentration gradient with multiple passes of the non-contact deposition system. For example, a first pass could be contain a high concentration of the biological active, and a subsequent pass could contain a low concentration of the same or a different biological active. This is beneficial for controlling the delivery of the biological active. Moreover, the fluid solution may be deposited in a manner such that the biological active is concentrated in certain areas of the surface 16. For example, the concentration of the biological active may be greater at the central regions of the surface 16 of the article 10, and less at the periphery. This allows lower concentrations of expensive biological actives to be used.

Examples of suitable biological actives for the second fluid solution include metal-ion forming compounds, fatty-acid monoesters, chlorhexidine, triclosan, peroxides, iodine, complexes thereof, derivatives thereof, and combinations thereof. This is particularly useful for coating a SSSC compound and another biological active on the same article, where the SSSC compound and the other biological active are incompatible in a single fluid solution (e.g., silver oxide and a fatty acid monoester). The small drop sizes and the rapid drying of the fluid solutions obtainable by non-contact deposition, reduces the risk of adverse interactions between the SSSC compound and the other biological active.

Combining the SSSC compound with another biological active may additionally provide synergistic properties. For example, combining a SSSC compound with a fatty acid monoester provides rapid antimicrobial activity due to the fatty acid monoester, combined with long-term antimicrobial activity due to the sustained release effect of the SSSC compound.

As discussed above, the fluid solution of the present invention desirably exhibits a sufficiently low viscosity to be coated by non-contact deposition. The desired viscosity will generally depend on the non-contact deposition technique used. For example, for inkjet printing, the fluid solution of the present invention desirably exhibits a viscosity below about 30 centipoise (i.e., 30 milliPascal-seconds), preferably below about 25 centipoise, and more preferably below about 20 centipoise at the desired inkjetting temperature (typically from about 25° C. to about 65° C.). However, the optimum viscosity characteristics for the fluid solution of the present invention will depend primarily upon the inkjetting temperature and the type of inkjet system used. For piezo inkjet applications, suitable viscosities for the fluid solution range from about 3 to about 30 centipoise, preferably from about 10 to about 16 centipoise, at temperatures ranging from about 25° C. to about 65° C.

Upon application by non-contact printing, the fluid solution may diffuse into the bulk of the article, remain on the article surface, or both. The extent of diffusion into the article depends on a variety of factors, such as the level of solubility between the fluid solution and the article, the processing conditions of the non-contact deposition, the composition of the fluid solution, and the composition of the article.

In one embodiment of the present invention, the fluid solution may exhibit low solubility with the article being coated. The low solubility between the fluid solution and the article prevents significant diffusion of the fluid solution into the article. As such, the SSSC compound remains concentrated on or near the article surface when the fluid solution substantially dries. This provides several benefits. First the article may incorporate low concentrations of the SSSC compound, while exhibiting effective levels of antimicrobial activity. Suitable concentrations of the SSSC compound concentrated on or near the article surface include concentrations of less than about 1.0 mg/inch² (about 1.55 grams/meter²), preferably less than about 0.5 mg/inch² (about 0.78 grams/meter²), and more preferably less than about 0.1 mg/inch² (about 0.16 grams/meter²). Additionally, because the SSSC compound remains concentrated on or near the article surface, the SSSC compound is not required to diffuse through the bulk of the article before being released. As such, when the article is applied to a wound site, the SSSC compound is rapidly released to protect against infections.

Suitable means for measuring the solubility of the fluid solution and the article is with Hildebrand solubility parameters and critical surface tensions, as disclosed in the 59804US002 application. As used herein, the Hildebrand solubility parameter of a mixture of multiple substances is based on the weighted average of the Hildebrand solubility parameters of the individual substances, based on the total weight of the mixture.

Examples of suitable solubilities for the fluid solution of the present invention include Hildebrand solubility parameters of at least about 3.7 MPa^{½} (about 1.8 (cal/cm³)^{½}) greater than the Hildebrand solubility parameter of the article being coated. Particularly suitable solubilities for the fluid solution of the present invention include Hildebrand solubility parameters of at least about 8.0 MPa^{½} (about 3.9 (cal/cm³)^{½}) greater than the Hildebrand solubility parameter of the article being coated. Even more particularly suitable solubilities for the fluid solution of the present invention include Hildebrand solubility parameters of at least about 15.0 MPa^{½} (about 7.3 (cal/cm³)^{½}) greater than the Hildebrand solubility parameter of the article being coated. Such differences in Hildebrand solubility parameters provide low solubilities between the fluid solution of the present invention and the article being coated.

This embodiment of the present invention is particularly suitable where the article (depicted sectionally in FIG. 1 as an article 10) includes an adhesive layer 12 disposed on a backing substrate 14 and having a surface 16, as disclosed in the 59804US002 application. After a fluid solution 18 is deposited on the surface 16 of the adhesive layer 12 and substantially dries, the SSSC compound remains concentrated on or near the surface 16. As discussed above, this allows the article 10 to incorporate low concentrations of the SSSC compound. The low concentrations of the SSSC compound reduces interactions between the SSSC compound and the adhesive layer. This allows the adhesive layer to retain good physical properties (e.g., good adhesive strengths, long wear, high moisture vapor transmission, preferred modulus values, and absorbency) despite the presence of the SSSC compound. This is particularly useful where the article 10 is a PSA wound dressing article. The article 10 retains good adherence to the skin of a patient during use, and releases the SSSC compound to the wound site to reduce the risk of infections.

After the fluid solution is applied to the article, the fluid solution is allowed to substantially dry. The fluid solution may be allowed to dry in a variety of manners, and may depend on the composition of the fluid solution and the non-contact deposition technique used. In general, rapid drying further reduces the extent that the fluid solution diffuses into the article.

The non-contact deposition techniques discussed above deposit small drop volumes of the fluid solution on the article surface (e.g., 70 pL for inkjet printing). As such, the drops generally exhibit large surface areas, which allow the fluid solution to rapidly dry upon application. After non-contact deposition, the article may be held at room temperature (25° C.) for a period of time to allow the fluid solution to substantially dry. The period of time will depend on the amount of fluid solution applied to the article surface and the composition of the fluid solution (e.g., 30 minutes to 48 hours). The rate of drying may alternatively be increased by holding the article at an elevated temperature (e.g., in a convective oven at 150° C.) for a period of time to allow the fluid solution to substantially dry (e.g., 5 to 10 minutes). Inline drying may also be used, and is particularly useful for webline coating operations. Upon drying, the SSSC compound and other components of the fluid solution that did not volatilize remain disposed within the article and/or remain concentrated on or near the article surface.

The SSSC compounds, once applied to the article, are desirably stable to at least one of the following types of radiation: Visible light, ultraviolet light, electron beam, and gamma ray sterilization. In certain embodiments, the SSSC compounds are stable to visible light, such that the SSSC compounds do not darken upon exposure to visible light. Such SSSC compounds are useful in medical articles, particularly wound dressings and wound packing materials, although a wide variety of other articles may be coated with the SSSC compounds.

### ARTICLES

A variety of articles may be prepared with a SSSC compound pursuant to the present invention. Preferably, the articles are medical articles, such as wound dressings, adhesive wound dressings, wound packing material, and other materials that are applied to wounds. Other suitable articles include clothing, bedding, masks, dust cloths, shoe inserts, filter media, diapers, household articles, and hospital materials such as blankets, surgical drapes and gowns.

Examples of suitable materials for articles that may be prepared with a SSSC compound pursuant to the present invention include fabric, non-woven or woven polymeric webs, knits, polymer films, hydrocolloids, foam, metallic foils, paper, gauze, natural or synthetic fibers, cotton, rayon, wool, hemp, jute, nylon, polyesters, polyacetates, polyacrylics, alginates, ethylene-propylene-diene rubbers, natural rubber, polyesters, polyisobutylenes, polyolefins (e.g., polypropylene polyethylene, ethylene propylene copolymers, and ethylene butylene copolymers), polyurethanes (including polyurethane foams), vinyls including polyvinylchloride and ethylene-vinyl acetate, polyamides, polystyrenes, fiberglass, ceramic fibers, elastomers, thermoplastic polymers, and combinations thereof.

The articles may also be porous (to allow the passage of wound exudate, moisture vapor, and air) or non-porous, substantially impervious to liquid, capable of absorbing liquid, or apertured liquid permeable substrate. Examples of suitable porous materials include knits, wovens (e.g., cheese cloth and gauze), nonwovens (e.g., spun-bonded nonwovens and blown micro fibers), extruded porous sheets, and perforated sheets.

The apertures (i.e., openings) in the porous materials are desirably of sufficient size and sufficient number to facilitate high breathability. Examples of suitable dimensions for the apertures in the porous materials range from about 1 aperture per square centimeter to about 225 apertures per square centimeter. Examples of suitable average opening sizes for the apertures (i.e., the largest dimension of the opening) range from about 0.1 millimeter to about 0.5 centimeters. Examples of suitable basis weight for the porous materials range from about 5 grams/meter² to about 200 grams/meter². The porous materials are preferably flexible, yet resistant to tearing. Examples of suitable thicknesses for the porous materials range from about 1/80 mm to about 3 mm.

For articles that include adhesive layers, such as the article 10 discussed above, the adhesive layers 12 are preferably pressure sensitive adhesives (PSA's). Examples of suitable materials for the adhesive layer 12 include PSA's based on acrylates, polyurethanes, silicones, rubber based adhesives (including natural rubber, polyisoprene, polyisobutylene, and butyl rubber), and combinations thereof. Examples of suitable acrylates include polymers of alkyl acrylate monomers such as methyl methacrylate, ethyl methacrylate, n-butyl methacrylate, methyl acrylate, ethyl acrylate, n-butyl acrylate, iso-octyl acrylate, iso-nonyl acrylate, 2-ethyl-hexyl acrylate, decyl acrylate, dodecyl acrylate, n-butyl acrylate, hexyl acrylate, and combinations thereof.

An example of particularly suitable materials for the adhesive layer 12 includes silicone-based adhesives, which exhibit several beneficial properties over traditional PSA's used in wound care applications. For example, silicone-based adhesives may be formulated to offer good skin adhesion characteristics, offer excellent conformability, and provide a gentle release from the skin and wound site. Typically, silicone adhesives are formed from the reaction of a polysiloxane gum and a resin as a two part system, one part hindered system to prevent premature reaction, or even as a hot melt system. Examples of suitable silicone adhesives include polydiorganosiloxane-based adhesives; adhesives commercially available under the trade designation “SILASTIC 7-6860” Biomedical Grade Adhesive from Dow Coming Corp., Midland, Mich.; adhesives disclosed in Sherman et al., U.S. Pat. No. 6,407,195, which is incorporated herein by reference in its entirety; and combinations thereof.

The article may also include liners that are disposed on the article surfaces (e.g., on adhesive layers) to protect the articles prior to use. Liners which are suitable for use with the article may be made of materials such as kraft papers, polyethylene, polypropylene, polyester, and combinations thereof. The liners are preferably coated with compositions containing release agents, such as polymerized fluorochemicals or silicones. The low surface energy of the liner provides for an easy removal from the article surface without substantially affecting the SSSC compound.

### PROPERTY ANALYSIS AND CHARACTERIZATION PROCEDURES

Various analytical techniques are available for characterizing the sealant materials of the present invention. Several of the analytical techniques are employed herein. An explanation of these analytical techniques follows.

Zone of Inhibition Test

Antimicrobial performance was quantitatively determined for articles prepared pursuant to the present invention using a zone of inhibition test, which was performed by the following method. A solution of staphylococcus aureus (A.T.C.C. 25923) was prepared at a concentration of 1×10⁸ colony forming units per milliliter (ml) in Phosphate Buffered Saline using a 0.5 McFarland Equivalence Turbidity Standard. Bacterial lawns were prepared by dipping a sterile cotton applicator into the solution and swabbing a dry surface of a trypticase soy agar plate in three different directions. Three 7-millimeter (mm) diameter discs for each sample were then placed onto the plate and pressed firmly against the agar with sterile forceps to ensure a complete contact with the agar.

The plate was held in a refrigerator at 4° C. for three hours and then incubated at 36° C.±1° C. for 24 hours. A measurement was then made of the diameter of the area around each sample (including the area under the 7-mm diameter sample disc) where inhibited growth and/or no growth was observed. The zone of inhibition was measured using primary and/or secondary zone of inhibitions. The primary zone of inhibition was defined as the diameter of the area that no growth was observed (including the area under the 7-mm diameter sample disk). The secondary zone of inhibition was defined as the diameter of the area that inhibited growth was observed (including the area of the primary zone of inhibition).

Time-Dependent Release Zone of Inhibition Test

Time-dependent antimicrobial performance was quantitatively determined for articles prepared pursuant to the present invention using an extended zone of inhibition test, which was performed by the following method. The inoculated plate and the sample discs were prepared, incubated, and measured pursuant to the “Zone of Inhibition Test” described above (i.e., the “Zone of Inhibition Test” was performed in its entirety). After the incubation and measurement, the sample discs were then aseptically removed from the agar surface and transferred to a freshly inoculated agar plate and retested pursuant to the “Zone of Inhibition Test”. This process was repeated until no zones of inhibition are observed.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following compositional abbreviations are used in the following Examples:
“Silver (I) oxide”: A silver oxide (Ag₂O) with a formula weight of 231.7, commercially available from Alfa Aesar, Ward Hill, Mass.
“Silver (II) oxide”: A silver oxide (AgO) with a formula weight of 123.9, commercially available from Alfa Aesar, Ward Hill, Mass.
“Silver acetate”: A silver acetate (AgCH₃CO₂) with a formula weight of 166.9, commercially available from Matheson, Coleman, and Bell Co., Norwood, Ohio.
“Silver sulfate”: A silver sulfate (Ag₂SO₄) with a formula weight of 311.8, commercially available from Mallinckrodt Chemical, St. Louis, Mo.
“Lauricidin”: a glycerol monolaurate fatty acid monoester, commercially available under the trade designation “LAURICIDIN” from Med-Chem Laboratories, East Lansing, Mich.
“Ammonium carbonate”: An ammonium carbonate ((NH₄)₂CO₃) with a formula weight of 96.1, commercially available from Sigma-Aldrich Chemical Company, Saint Louis, Mo.
“Ammonium acetate”: An ammonium acetate (NH₄CH₃CO₂) with a formula weight of 77., commercially available from Sigma-Aldrich Chemical Company, Saint Louis, Mo.
“Ammonium pentaborate”: An ammonium pentaborate (NH₄B₅O₈) with a formula weight of 196.0, commercially available from Sigma-Aldrich Chemical Company, Saint Louis, Mo.
“Ammonia”: 28% ammonia (NH₃) with a formula weight of 17.0 in water, commercially available from Sigma-Aldrich Chemical Company, Saint Louis, Mo.
“Brij 700”: A polyoxyethylene stearyl ether, commercially available under the trade designation “BRIJ 700” from Imperial Chemical Industries PLC, London, UK.
“Jeffamine T-403”: A polyether triamine epoxy curing agent, commercially available under the trade designation “JEFFAMINE T-403”, from Huntsman Corporation, Houston, Tex.
“DOSS surfactant”: A dioctylsulfosuccinate (DOSS) surfactant, commercially available from Alfa Aesar, Ward Hill, Mass.
“Salicylic acid”: A 2-hydroxybenzoic acid (HOC₆H₈CO₂H) with a formula weight of 138.1, commercially available from Sigma-Aldrich Chemical Company, Saint Louis, Mo.
“Isopropanol”: A 2-propanol ((CH3)CHOH) with a formula weight of 60. 1, commercially available from EM Science, Gibbstown, N.J.
“Tegaderm”: A wound care product with a polyurethane backing and a press-sensitive adhesive layer, commercially available under the trade designation “TEGADERM” Dressing from 3M Corporation, St. Paul, Minn.
“Paper-backed Tegaderm”: A wound care product with a paper backing and a press-sensitive adhesive layer, commercially available under the trade designation “TEGADERM” Dressing from 3M Corporation, St. Paul, Minn.
“Tegaderm HP”: A wound care product with a polyurethane backing and a high moisture transmissive press-sensitive adhesive layer, commercially available under the trade designation “TEGADERM HP” Dressing from 3M Corporation, St. Paul, Minn.
“Gauze” Cotton nonwoven, 80 grams/meter², available from Cotton Incorporated, Cary, N.C.
“Foam” Open cell polyurethane foam available from 3M Corporation, St. Paul, Minn.
“Acticoat 7”: A silver-releasing wound dressing commercially available under the trade designation “ACTICOAT 7”, from Westaim Biomedical Corporation, Wakefield, Mass. The wound dressing is believed to include about 3 milligrams/inch² of silver on a high-density polyethylene mesh.
“Silastic adhesive”: A silicone pressure sensitive adhesive commercially available under the trade designation “SILASTIC 7-6860” Biomedical Grade Adhesive from Dow Corning Corp., Midland, Mich.

### Example 1

A fluid solution of 1.0% silver (I) oxide and 5.0% ammonium carbonate in water was prepared by heating the mixture to 60° C. and stirring until the silver (I) oxide was dissolved. The fluid solution was inkjet printed at 100% surface coverage onto the adhesive surface of Tegaderm with a “XAAR XJ128-200 printhead”. The printhead was peizoelectrically driven at 1.25 kHz and 35 V, with a printing resolution of 300×300 dpi. This generated drops of the fluid solution with nominal volumes of about 70 pL. The coated adhesive surface was then dried in an oven at 150° C. for 10 minutes.

### Example 2

The fluid solution of Example 1 was inkjet printed at 200% surface coverage onto the adhesive surface of Tegaderm and dried, pursuant to the inkjet printing method described in Example 1.

### Example 3

The fluid solution of Example 1 was inkjet printed at 100% surface coverage onto the adhesive surface of Tegaderm HP and dried, pursuant to the inkjet printing method described in Example 1.

### Example 4

A fluid solution of 2.0% silver (I) oxide and 10.0% ammonium carbonate in water was prepared by heating the mixture to 60° C. and stirring until the silver (I) oxide was dissolved. After 10 months this solution did not show any settling or discoloration. The fluid solution was inkjet printed at 100% surface coverage onto the adhesive surface of Tegaderm and dried, pursuant to the inkjet printing method described in Example 1.

### Example 5

The fluid solution of Example 4 was inkjet printed at 200% surface coverage onto the adhesive surface of Tegaderm and dried, pursuant to the inkjet printing method described in Example 1.

### Example 6

A fluid solution of 3.0% silver (II) oxide and 5.0% ammonium carbonate in water was prepared by stirring the mixture until the silver (II) oxide was dissolved. The fluid solution was inkjet printed at 50% surface coverage onto the adhesive surface of Tegaderm and dried, pursuant to the inkjet printing method described in Example 1.

### Example 7

The fluid solution of Example 6 was inkjet printed at 80% surface coverage onto the adhesive surface of Tegaderm and dried, pursuant to the inkjet printing method described in Example 1.

### Example 8

The fluid solution of Example 6 was inkjet printed at 100% surface coverage onto the adhesive surface of Tegaderm and dried, pursuant to the inkjet printing method described in Example 1.

### Example 9

The fluid solution of Example 1 was inkjet printed at 120% surface coverage onto the adhesive surface of Tegaderm and dried, pursuant to the inkjet printing method described in Example 1.

### Example 10

A fluid solution of 2.0% silver (I) oxide and 5.0% ammonium carbonate in water was prepared by heating the mixture to 60° C. and stirring until the silver (I) oxide was dissolved. The fluid solution was inkjet printed at 120% surface coverage onto the adhesive surface of Tegaderm and dried, pursuant to the inkjet printing method described in Example 1.

### Example 11

A fluid solution of 1.0% silver (II) oxide and 5.0% ammonium carbonate in water was prepared by stirring the mixture until the silver (II) oxide was dissolved. The fluid solution was inkjet printed at 120% surface coverage onto the adhesive surface of Tegaderm and dried, pursuant to the inkjet printing method described in Example 1.

### Example 12

A fluid solution of 2.0% silver (II) oxide and 5.0% ammonium carbonate in water was prepared by stirring the mixture until the silver (II) oxide was dissolved. The fluid solution was inkjet printed at 120% surface coverage onto the adhesive surface of Tegaderm and dried, pursuant to the inkjet printing method described in Example 1.

### Example 13

The fluid solution of Example 6 was inkjet printed at 120% surface coverage onto the adhesive surface of Tegaderm and dried, pursuant to the inkjet printing method described in Example 1.

### Example 14

A fluid solution of 1.0% silver acetate, 5.0% ammonium acetate, and 1.5% ammonia in water was prepared by stirring the mixture until the silver acetate was dissolved. The fluid solution was inkjet printed at 160% surface coverage onto the adhesive surface of Tegaderm and dried, pursuant to the inkjet printing method described in Example 1. Upon mixing, the fluid solution of Example 14 was transparent, and after five months at 25° C., no settling of the silver compound or discoloration was observed.

### Example 15

The fluid solution of Example 14 was inkjet printed at 160% surface coverage onto gauze and dried, pursuant to the inkjet printing method described in Example 1.

### Example 16

A fluid solution of 1.0% silver sulfate and 5.0% ammonium acetate in water was prepared by heating the mixture to 70° C. and stirring until the silver sulfate was dissolved. The fluid solution was inkjet printed at 160% surface coverage onto the adhesive surface of Tegaderm and dried, pursuant to the inkjet printing method described in Example 1. Upon mixing, the fluid solution of Example 16 was transparent, and after five months at 25° C., no settling of the silver compound or discoloration was observed.

### Example 17

The fluid solution of Example 16 was inkjet printed at 160% surface coverage onto gauze and dried, pursuant to the inkjet printing method described in Example 1.

### Example 18

A fluid solution of 1.0% silver acetate and 2.0% Brij 700 in water was prepared by heating the mixture to 60° C. and stirring until the silver acetate was dispersed. The fluid solution was inkjet printed at 20% surface coverage onto the adhesive surface of Tegaderm and dried, pursuant to the inkjet printing method described in Example 1.

Upon mixing, the fluid solution of Example 18 was transparent. However, the fluid solution began to darken after several hours at 25° C. After 24 hours at 25° C., a dark precipitate was formed. Nonetheless, the silver acetate was dispersed in the fluid long enough to be inkjet printed.

### Example 19

A fluid solution of 1.0% silver acetate, 2.0% Brij 700, and 2.0% ammonium carbonate in water was prepared by heating the mixture to 60° C. and stirring until the silver acetate was dispersed. The fluid solution was inkjet printed at 40% surface coverage onto the adhesive surface of Tegaderm and dried, pursuant to the inkjet printing method described in Example 1. Upon mixing, the fluid solution of Example 19 was transparent, and after several days at 25° C., no settling of the silver compound or discoloration was observed.

### Example 20

A fluid solution of 1.5% silver acetate, 4.0% Brij 700, and 4.0% Jeffamine T-403 in water was prepared by heating the mixture to 60° C. and stirring until the silver acetate was dispersed. The fluid solution was inkjet printed at 100% surface coverage onto the adhesive surface of Tegaderm and dried, pursuant to the inkjet printing method described in Example 1.

Upon mixing, the fluid solution of Example 20 was transparent with a slight brownish tint, which became darker brown with time. However, after two months at 25° C., no settling of the silver compound was observed and the fluid solution remained transparent.

### Example 21

The fluid solution of Example 20 was inkjet printed at 80% surface coverage onto foam and dried, pursuant to the inkjet printing method described in Example 1.

### Example 22

A fluid solution of 2.0% silver carbonate, 5.0% ammonium acetate, and 1.5% ammonia in water was prepared by stirring the mixture until the silver carbonate was dissolved. The fluid solution was inkjet printed at 80% surface coverage onto the adhesive surface of Tegaderm, pursuant to the inkjet printing method described in Example 1, except that the coated sample was dried at room temperature (25° C.) for 48 hours. Upon mixing, the fluid solution of Example 22 was transparent, and after five months at 25° C., no settling of the silver compound or discoloration was observed.

### Example 23

The fluid solution of Example 6 was inkjet printed at 100% surface coverage onto an adhesive surface of a silicone pressure sensitive adhesive (PSA) article, pursuant to the inkjet printing method described in Example 1, except that the coated sample was dried in an oven at 150° C. for 5 minutes.

The silicone PSA layer was prepared by mixing 30 grams of Part A and 30 grams of Part B of a Silastic adhesive. The mixed Silastic adhesive was coated onto a 50 micrometer-thick polyester film at a 50 micrometer gap via knife coating. The silicone PSA article was then cured at 100° C. for 15 minutes to react the silicone gum and resin to form a silicone PSA layer.

### Example 24

The fluid solution of Example 6 was inkjet printed at 100% surface coverage onto the adhesive surface of the silicone PSA article of Example 22, pursuant to the inkjet printing method described in Example 1, except that the coated sample was dried at room temperature (25° C.) for 24 hours.

### Example 25

A fluid solution of 5.0% silver (I) oxide and 16.6% ammonium carbonate in water was prepared by heating the mixture to 60° C. and stirring until the silver (I) oxide was dissolved. The fluid solution was inkjet printed at 30% surface coverage onto the adhesive surface of Tegaderm and dried, pursuant to the inkjet printing method described in Example 1.

### Example 26

The fluid solution of Example 25 was inkjet printed at 30% surface coverage onto foam and dried, pursuant to the inkjet printing method described in Example 1.

### Example 27

The fluid solution of Example 25 was inkjet printed at 30% surface coverage onto foam, pursuant to the inkjet printing method described in Example 1. The fluid solution was then printed again at 100% surface coverage at defined locations on the foam to create printed indicia, which stated “3M SILVER”. The coated sample was then dried at 150° C. for 5 minutes. When printed, the coated fluid solution was colorless, but became dark brown after drying to visually show the printed indicia.

### Example 28

The fluid solution of Example 1 was inkjet printed at 200% surface coverage onto the adhesive surface of paper-backed Tegaderm and dried, pursuant to the inkjet printing method described in Example 1.

### Example 29

The fluid solution of Example 6 was inkjet printed at 200% surface coverage onto the adhesive surface of gauze and dried, pursuant to the inkjet printing method described in Example 1.

### Example 30

A fluid solution of 1.0% silver (I) oxide and 5.0% ammonium pentaborate in water was prepared by heating the mixture to 60° C. and stirring until the silver (I) oxide was dissolved. The fluid solution was inkjet printed at 60% surface coverage onto the adhesive surface of Tegaderm and dried, pursuant to the inkjet printing method described in Example 1. Upon mixing, the fluid solution of Example 30 was transparent, and after several days at 25° C., slight settling of the silver compound was observed.

### Example 31

The fluid solution of Example 30 was inkjet printed at 120% surface coverage onto the adhesive surface of Tegaderm and dried, pursuant to the inkjet printing method described in Example 1.

### Example 32

A fluid solution of 0.6% silver (I) oxide and 3.0% ammonium pentaborate in water was prepared by heating the mixture to 60° C. and stirring until the silver (I) oxide was dissolved. The fluid solution was inkjet printed at 80% surface coverage onto the adhesive surface of Tegaderm, pursuant to the inkjet printing method described in Example 1, except that the coated sample was dried at room temperature (25° C.) for 48 hours. Upon mixing, the fluid solution of Example 32 was transparent, and after two days at 25° C., slight settling of the silver compound was observed.

### Example 33

The fluid solution of Example 6 was inkjet printed at 100% surface coverage onto foam and dried, pursuant to the inkjet printing method described in Example 1.

### Example 34

The fluid solution of Example 6 was inkjet printed at 100% surface coverage onto foam and dried, pursuant to the inkjet printing method described in Example 1. The printhead was then flushed with water and isopropanol.

A fluid solution of 20.0% Lauricidin, 10.0% salicylic acid, and 10.0% Doss surfactant in isopropanol was prepared by stirring the mixture until the Lauricidin was dissolved. The fluid solution was inkjet printed at 100% surface coverage onto the same polyurethane foam and dried, pursuant to the inkjet printing method described in Example 1, except that the coated sample was dried at room temperature (25° C.) for 24 hours.

### Example 35

The fluid solution of Example 6 was inkjet printed at 100% surface coverage onto a non-woven polypropylene blown micro fiber web and dried, pursuant to the inkjet printing method described in Example 1.

### Example 36

The fluid solution of Example 6 was inkjet printed at 100% surface coverage onto a non-woven polypropylene blown micro fiber web and dried, pursuant to the inkjet printing method described in Example 1. The printhead was then flushed with water and isopropanol.

A fluid solution of 20.0% Lauricidin, 10.0% salicylic acid, and 10.0% Doss surfactant in isopropanol was prepared by stirring the mixture until the Lauricidin was dissolved. The fluid solution was inkjet printed at 100% surface coverage onto the same non-woven polypropylene blown micro fiber web and dried, pursuant to the inkjet printing method described in Example 1, except that the coated sample was dried at room temperature (25° C.) for 24 hours.

### Example 37

The fluid solution of Example 6 was deposited by spay atomization deposition at 20 ml/min onto the adhesive surface of paper-backed Tegaderm with “Coolnozzle 45” spray head with a fan spray adaptation, available from 3M Corporation, St. Paul, Minn., and a ⅛ VUA-SS body, commercially available from Spraying Systems Co., Wheaton, Ill. The atomizer nozzle setting was 23 psi (159 kpa) and the fan nozzle setting was 20 psi (138 kpa). The spray head generated droplets with diameters ranging from about 2 micrometers to about 20 micrometers. The coated sample was then dried in an oven at 150° C. for 10 minutes.

### Example 38

The fluid solution of Example 6 deposited by spay atomization deposition at 20 ml/min onto spunbond respirator film and dried, pursuant to spray atomization deposition method described in Example 37, except that the fluid solution was sprayed three times (in three passes) prior to drying.

### Example 39

The fluid solution of Example 1 deposited by spay atomization deposition at 10 ml/min onto PET film and dried, pursuant to spray atomization deposition method described in Example 37.

### Example 40

The fluid solution of Example 1 deposited by spay atomization deposition at 15 ml/min onto PET film and dried, pursuant to spray atomization deposition method described in Example 37.

### Example 41

The fluid solution of Example 1 deposited by spay atomization deposition at 20 ml/min onto PET film and dried, pursuant to spray atomization deposition method described in Example 37.

### Zone of Inhibition Testing for Examples 1-19, 21-27, and 30-41

A zone of inhibition test was performed on the coated samples of Examples 1-19, 21-27, and 30-41 and on Acticoat 7 (Comparative Example A), pursuant to the above-described method entitled “Zone of Inhibition Test”. Tables 1 and 2 provide the primary and secondary zone of inhibition (ZOI) results for the coated samples of Examples 1-19, 21-27, 30-32, and 37-41, and Comparative Example A.

TABLE 1

| | | Percent | | |
|---|---|---|---|---|
| | Percent by Weight of | Surface | Primary | Secondary |
| Example | SSSC Compound* | Coverage | ZOI (mm) | ZOI (mm) |
| Example 1 | 1.0% Ag₂O | 100% | 10 | 12 |
| Example 2 | 1.0% Ag₂O | 200% | 10 | 12 |
| Example 3 | 1.0% Ag₂O | 100% | 11 | 13 |
| Example 4 | 2.0% Ag₂O | 100% | 10 | 11 |
| Example 5 | 2.0% Ag₂O | 200% | 11 | 13 |
| Example 6 | 3.0% AgO | 50% | 10 | None |
| Example 7 | 3.0% AgO | 80% | 11 | None |
| Example 8 | 3.0% AgO | 100% | 11 | 12 |
| Example 9 | 1.0% Ag₂O | 120% | 10 | 12 |
| Example 10 | 2.0% Ag₂O | 120% | 11 | 13 |
| Example 11 | 1.0% AgO | 120% | 8** | 11 |
| Example 12 | 2.0% AgO | 120% | 11 | 14 |
| Example 13 | 3.0% AgO | 120% | 12 | 15 |
| Example 14 | 1.0% AgCH₃CO₂ | 160% | 10 | 13 |
| Example 15 | 1.0% AgCH₃CO₂ | 160% | None | 9 |
| Example 16 | 1.0% Ag₂SO₄ | 160% | 10 | 14 |
| Example 17 | 1.0% Ag₂SO₄ | 160% | 8** | 11 |
| Comparative | — | — | 11 | 12 |
| Example A | | | | |

*Based on the total weight of the fluid solution.
**Trace growth was observed under the sample disc.

TABLE 2

| | | Percent | | |
|---|---|---|---|---|
| | Percent by Weight of | Surface | Primary | Secondary |
| Example | SSSC Compound* | Coverage | ZOI (mm) | ZOI (mm) |
| Example 18 | 1.0% AgCH₃CO₂ | 20% | None | None*** |
| Example 19 | 1.0% AgCH₃CO₂ | 40% | None | None*** |
| Example 21 | 1.5% AgCH₃CO₂ | 80% | None | 9*** |
| Example 22 | 2.0% Ag₂CO₃ | 80% | 9 | 11 |
| Example 23 | 3.0% AgO | 100% | 9 | 15 |
| Example 24 | 3.0% AgO | 100% | 10 | 12 |
| Example 25 | 5.0% Ag₂O | 30% | 11 | None |
| Example 26 | 5.0% Ag₂O | 30% | 10 | None |
| Example | 5.0% Ag₂O | 100% | 12 | 14 |
| 27**** | | | | |
| Example 30 | 1.0% Ag₂O | 60% | 9 | None |
| Example 31 | 1.0% Ag₂O | 120% | 11 | 13 |
| Example 32 | 0.5% Ag₂O | 80% | 11 | None |
| Example 37 | 2.0% Ag₂CO₃ | — | 9 | None |
| Example 38 | 2.0% Ag₂CO₃ | — | 11 | 12 |
| Example 39 | 1.0% Ag₂O | — | 9** | None |
| Example 40 | 1.0% Ag₂O | — | 10 | None |
| Example 41 | 1.0% Ag₂O | — | 10 | None |
| Comparative | — | — | 11 | 12 |
| Example A | | | | |

*Based on the total weight of the fluid solution.
**Trace growth was observed under the sample disc.
***Moderate inhibition of bacterial growth was observed under the sample disc
****The tested portion of the sample of Example 27 included the printed indicia.

The data provided in Tables 1 and 2 illustrate the antimicrobial activity exhibited by the coated samples prepared pursuant to the present invention. The coated samples of almost all of the Examples exhibited similar antimicrobial levels to Acticoat 7 (Comparative Example A), which contains about 3 mg/inch² silver. Based on the concentration calculation discussed above for inkjet printing, the coated samples for Examples 1-19, 21-27, and 30-41 contained about 0.06 mg/inch² to about 0.20 mg/inch² silver, which is substantially less than the concentration of Acticoat 7. As such, the coated samples of Examples 1-19, 21-27, and 30-41 exhibit effective levels of antimicrobial activity with low concentrations of silver.

The data in Tables 1 and 2 also illustrates that the coated samples with greater concentrations of silver correspondingly exhibited greater zones of inhibition. This is observable in two manners. First, the coated samples of Examples 6-8 were printed with a fluid solution containing 3.0% silver (II) oxide. However, the percent surface coverages varied (i.e., 50%, 80%, and 100% respectively). As discussed above, the concentration of silver on the coated samples is proportional to the percent surface coverage. Therefore, the coated sample of Example 8 contained the greatest amount of silver and the coated sample of Example 6 contained the least amount of silver. As shown in Table 1, the zones of inhibition correspondingly follow this trend of increased silver concentration.

Similarly, the coated samples of Examples 9-13 were printed with the same percent surface coverage (i.e., 120%), but with varying silver concentrations. The coated samples of Examples 9 and 10 were printed with fluid solutions containing 1.0% and 2.0% silver (I) oxide, respectively, and the Examples 11-13 were printed with fluid solutions containing 1.0%, 2.0%, and 3.0% silver (II) oxide, respectively. As shown in Table 1, the increasing concentrations of the respective silver oxides corresponds with the increased zone of inhibition.

Table 3 provides the primary and secondary zone of inhibition (ZOI) results for the coated samples of Examples 33-36 and Comparative Example A, illustrating the effect of applying a SSSC compound with an additional biological active (i.e., Lauricidin) on the same article via separate inkjet printing steps.

TABLE 3

| | Percent | Percent | | |
|---|---|---|---|---|
| | by Weight | by Weight | Primary | Secondary |
| Example | of AgO* | of Lauricidin* | ZOI (mm) | ZOI (mm) |
| Example 33 | 3.0% | 0.0% | 9 | 11 |
| Example 34 | 3.0% | 20.0% | 21 | None |
| Example 35 | 3.0% | 0.0% | 8 | 9 |
| Example 36 | 3.0% | 20.0% | 17 | None |
| Comparative | — | — | 10 | None |
| Example A | | | | |

*Based of the total weight of the corresponding fluid solution.

The data provided in Table 3 illustrates the increased antimicrobial activity exhibited by the coated samples prepared with both silver oxide and Lauricidin. The coated samples of Examples 33 and 35 exhibited similar antimicrobial levels to Acticoat 7 (Comparative Example A). However, as shown by the coated samples of Examples 34 and 36, the addition of the Lauricidin substantially increases the antimicrobial activity compared to the coated samples of Examples 33 and 35, respectively. This illustrates the benefit of using separate non-contact deposition systems (or separate and sequential depositions using a single non-contact deposition system).

This is particularly useful for coating an article with silver oxide and Lauricidin. As discussed above, silver oxide and fatty acid monoesters (e.g., Lauricidin) are generally incompatible in a single fluid solution. However, through the use of separate inkjet printing steps, the silver oxide and the Lauricidin may be applied to a single article, allowing the article to exhibit increased antimicrobial activity. Moreover, fatty acid monoesters, such as Lauricidin, are rapidly released upon exposure to moisture from a wound bed, which provides fast antimicrobial activity to prevent bacterial infections. In contrast, the low solubility of the silver oxide with the moisture causes the silver ions to release at a slower rate. This provides a slower and sustained antimicrobial activity to the wound site relative to the fatty acid monoesters. As such, the combined use of the silver oxide and Lauricidin provides for a two-tiered synergistic antimicrobial activity.

### Time-Dependent Release Zone of Inhibition Testing for Examples 28 and 29

A time-dependent release zone of inhibition test was performed on the coated samples of Examples 28 and 29, pursuant to the above-described method entitled “Time-Dependent Release Zone of Inhibition Test”. Table 4 provides the primary and secondary zone of inhibition (ZOI) results for the coated sample of Examples 28 and Table 5 provides the primary and secondary zone of inhibition (ZOI) results for the coated sample of Examples 29.

TABLE 4

| Example 28 | Primary ZOI | | Growth under |
|---|---|---|---|
| (day) | (mm) | Secondary ZOI (mm) | samples |
| 1 | 10 | 12 | No growth |
| 2 | 9 | 10 | No growth |
| 3 | 9 | 10 | No growth |
| 4 | 9 | 0 | No growth |
| 5 | None | None | Light growth |

TABLE 5

| Example 29 | Primary ZOI | | Growth under |
|---|---|---|---|
| (day) | (mm) | Secondary ZOI (mm) | samples |
| 1 | 10 | 11 | No growth |
| 2 | 8 | None | No growth |
| 3 | None | None | Moderate growth |

The data provided in Tables 4 and 5 illustrate the slow and sustained release of the silver ions from the coated samples of Examples 28 and 29 over time. Because the silver oxides used are SSSC compounds, the silver ions release slowly into the moist environment, allowing the concentration of silver ions to be sustained for several days. This allows wound care products prepared pursuant to the present invention with SSSC compounds to retain antimicrobial effectiveness for several days.

Additionally, the coated sample of example 28 exhibited sustained antimicrobial activity for a greater period of time compared to the coated sample of example 29. This is believed to be due to the silver (I) oxide used with the coated sample of example 28 and the silver (II) oxide used with the coated sample of example 29. As shown, silver (I) oxide provides a greater amount of silver ions compared to silver (II) oxide. As such, articles may be coated with a low concentration of silver (I) oxide pursuant to the present invention, while still retaining effective antimicrobial activity over a time period.

Although the present invention has been described with reference to preferred embodiments, workers skilled in the art will recognize that changes may be made in form and detail without departing from the spirit and scope of the invention.

The complete disclosures of the patents, patent documents and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A method of coating an article having a surface, the method comprising:
combining a sparingly soluble silver-containing compound, an ammonium-containing compound, and an aqueous solvent, thereby forming a fluid solution;
non-contact depositing the fluid solution on the surface; and
allowing the fluid solution to substantially dry.

2. The method of claim 1, wherein the sparingly soluble silver-containing compound is selected from the group consisting of silver oxide, silver sulfate, silver acetate, silver chloride, silver phosphate, silver stearate, silver thiocyanate, silver proteinate, silver carbonate, silver sulfadiazine, silver alginate, and combinations thereof.

3. The method of claim 1, wherein the sparingly soluble silver-containing compound constitutes about 0.1% to about 15.0% by weight of the fluid solution, based on the total weight of the fluid solution.

4. The method of claim 3, wherein the sparingly soluble silver-containing compound constitutes about 1.0% to about 5.0% by weight of the fluid solution, based on the total weight of the fluid solution.

5. The method of claim 1, wherein the ammonium-containing compound is selected from the group consisting of ammonium-containing compounds include ammonium salts such as ammonium pentaborate, ammonium acetate, ammonium carbonate, ammonium chloride, ammonium peroxyborate, ammonium tertraborate, triammonium citrate, ammonium carbamate, ammonium bicarbonate, ammonium malate, ammonium nitrate, ammonium nitrite, ammonium succinate, ammonium sulfate, ammonium tartarate, and combinations thereof.

6. The method of claim 1, wherein the ammonium-containing compound constitutes about 1.0% to about 25.0% by weight of the fluid solution, based on the total weight of the fluid solution.

7. The method of claim 1, wherein the non-contact deposition comprises inkjet printing.

8. The method of claim 1, wherein the non-contact deposition comprises spray atomization deposition.

9. The method of claim 1, wherein the fluid solution exhibits a Hildebrand solubility parameter of at least about 3.7 MegaPascals^{½} greater than the Hildebrand solubility parameter of the surface.

10. The method of claim 9, wherein the fluid solution exhibits a Hildebrand solubility parameter of at least about 8.0 MegaPascals^{½} greater than the Hildebrand solubility parameter of the surface.

11. The method of claim 10, wherein the fluid solution exhibits a Hildebrand solubility parameter of at least about 15.0 MegaPascals^{½} greater than the Hildebrand solubility parameter of the surface.

12. The method of claim 1, wherein the fluid solution is stable for at least about one month.

13. A method of coating a substrate, the method comprising:
combining silver oxide, ammonium carbonate, and an aqueous solvent, thereby forming a fluid solution;
non-contact depositing the fluid solution on the substrate; and
allowing the fluid solution to substantially dry.

14. The method of claim 13, wherein a portion of the silver oxide complexes with a portion of the ammonium carbonate to form silver ammonium carbonate.

15. The method of claim 14, wherein a portion of the silver ammonium carbonate forms silver oxide upon the fluid solution substantially drying.

16. The method of claim 13, wherein the silver oxide constitutes about 0.1% to about 15.0% by weight of the fluid solution, based on the total weight of the fluid solution.

17. The method of claim 16, wherein the silver oxide constitutes about 1.0% to about 5.0% by weight of the fluid solution, based on the total weight of the fluid solution.

18. The method of claim 13, wherein the fluid solution is stable for at least about one month.

19. A method of coating an article having a surface, the method comprising:
combining silver acetate, a dispersant, and an aqueous solvent, thereby forming a fluid solution;
non-contact depositing the fluid solution on the surface; and
allowing the fluid solution to substantially dry.

20. The method of claim 19, wherein the dispersant comprises a nonionic surfactant.

21. The method of claim 19, wherein an ammonium-containing compound is further combined with the silver acetate, the dispersant, and the aqueous solvent to thereby form the fluid solution.

22. The method of claim 19, wherein the silver acetate constitutes about 0.1% to about 15.0% by weight of the fluid solution, based on the total weight of the fluid solution.

23. The method of claim 19, wherein the silver acetate constitutes about 1.0% to about 5.0% by weight of the fluid solution, based on the total weight of the fluid solution.

24. The method of claim 19, wherein the fluid solution is stable for at least about one month.

25. A method of coating an article having a surface, the method comprising:
combining a sparingly soluble silver-containing compound, an ammonium-containing compound, and an aqueous solvent, thereby forming a first fluid solution;
providing a second fluid solution comprising a biological active;
non-contact depositing the first fluid solution and the second fluid solution on the surface;
allowing the first fluid solution and the second fluid solution to substantially dry.

26. The method of claim 25, wherein the sparingly soluble silver-containing compound is selected from the group consisting of silver oxide, silver sulfate, silver acetate, silver chloride, silver lactate, silver phosphate, silver stearate, silver thiocyanate, silver proteinate, silver carbonate, silver sulfadiazine, silver alginate, and combinations thereof.

27. The method of claim 25, wherein the biological active is selected from a group consisting of a metal-ion forming compound, a fatty-acid monoester, chlorhexidine, triclosan, a peroxide, iodine, complexes thereof, derivatives thereof, and combinations thereof.

28. The method of claim 25, wherein the sparingly soluble silver-containing compound comprises silver oxide.

29. The method of claim 28, wherein the biological active comprises a fatty acid monoester.

30. The method of claim 25, wherein the first fluid solution is non-contact deposited on the surface prior to the second fluid solution being non-contact deposited on the surface.

31. The method of claim 25, wherein the second fluid solution is non-contact deposited on the surface prior to the first fluid solution being non-contact deposited on the surface.

32. The method of claim 25, wherein the first fluid solution is non-contact deposited on the surface substantially simultaneously to the second fluid solution being non-contact deposited on the surface.

33. The method of claim 25, wherein the sparingly soluble silver-containing compound constitutes about 0.1% to about 15.0% by weight of the first fluid solution, based on the total weight of the first fluid solution.

34. The method of claim 33, wherein the sparingly soluble silver-containing compound constitutes about 1.0% to about 5.0% by weight of the first fluid solution, based on the total weight of the first fluid solution.

35. An article comprising:
a surface; and
a sparingly soluble silver-containing compound deposited on the surface by non-contact deposition of a fluid solution, the fluid solution formed by combining the sparingly soluble silver-containing compound, an ammonium-containing compound, and an aqueous solvent.

36. The article of claim 35, wherein the sparingly soluble silver-containing compound is selected from the group consisting of silver oxide, silver sulfate, silver acetate, silver chloride, silver lactate, silver phosphate, silver stearate, silver thiocyanate, silver proteinate, silver carbonate, silver sulfadiazine, silver alginate, and combinations thereof.

37. The article of claim 35, wherein the ammonium-containing compound is selected from the group consisting of ammonium-containing compounds include ammonium salts such as ammonium pentaborate, ammonium acetate, ammonium carbonate, ammonium chloride, ammonium peroxyborate, ammonium tertraborate, triammonium citrate, ammonium carbamate, ammonium bicarbonate, ammonium malate, ammonium nitrate, ammonium nitrite, ammonium succinate, ammonium sulfate, ammonium tartarate, and combinations thereof.

38. The article of claim 35, wherein the sparingly soluble silver-containing compound constitutes about 0.1% to about 15.0% by weight of the fluid solution, based on the total weight of the fluid solution.

39. The article of claim 38, wherein the sparingly soluble silver-containing compound constitutes about 1.0% to about 5.0% by weight of the fluid solution, based on the total weight of the fluid solution.

40. The article of claim 35, wherein the sparingly soluble silver-containing compound is concentrated on the surface at less than about 0.78 grams/meter².

41. The article of claim 40, wherein the sparingly soluble silver-containing compound is concentrated on the surface at less than about 0.16 grams/meter².

42. The article of claim 40, wherein the sparingly soluble silver-containing compound comprises silver oxide.

43. The article of claim 40, wherein the ammonium-containing compound comprises ammonium carbonate.

44. The article of claim 35 wherein a portion of the sparingly soluble silver-containing compound is disposed within the article.

45. The article of claim 35 wherein the sparingly soluble silver-containing compound is substantially concentrated on the surface.

46. The article of claim 35, wherein the fluid solution exhibits a Hildebrand solubility parameter of at least about 3.7 MegaPascals^{½} greater than the Hildebrand solubility parameter of the surface.

47. The article of claim 46, wherein the fluid solution exhibits a Hildebrand solubility parameter of at least about 8.0 MegaPascals^{½} greater than the Hildebrand solubility parameter of the surface.

48. The article of claim 47, wherein the fluid solution exhibits a Hildebrand solubility parameter of at least about 15.0 MegaPascals^{½} greater than the Hildebrand solubility parameter of the surface.

49. The article of claim 35, wherein the surface comprises an adhesive layer.

50. The article of claim 49, wherein the adhesive layer comprises a press-sensitive adhesive.

51. The article of claim 49, wherein the adhesive layer is derived from an adhesive material selected from a group consisting of acrylates, polyurethanes, silicones, natural rubber, polyisoprene, polyisobutylene, butyl rubber, and combinations thereof.
